(19) United States
(12) Patent Application Publication
(10) Pub. No.: US 2002/0174500 A1
(43) Pub. Date: Nov. 28, 2002

(54) Wipe for removing stains from fabrics and carpets

(75) Inventors: Robert P. Micciche, Somerset, NJ (US); Catherine Durden, Midland Park, NJ (US); Uma Tripathi, Gladstone, NJ (US); Anthony J. Mauro, Allenhurst, NJ (US)

Correspondence Address: Charles N.J. Ruggiero, Esq., Ohlandt, Greeley, Ruggiero & Perle, L.L.P., 10th Floor, One Landmark Square, Stamford, CT, 06901-2682, US

(73) Assignee: Playtex products, Inc.

(21) Appl. No.: 10/043,872

(22) Filed: Jan. 10, 2002

Related U.S. Application Data
(60) Provisional application No. 60/261,399, filed on Jan. 12, 2001.

(51) Int. Cl. C11D 17/00

(52) U.S. Cl. 15/104.93; 510/438; 510/439

(57) ABSTRACT

There is provided a cleaning wipe impregnated with a cleaning composition. The cleaning composition includes at least one surfactant, at least one preservative, and a carrier. In addition, the wipe cleaning composition may have at least one enhancing agent. The at least one enhancing agent includes a skin softening and conditioning agent, a pH control agent, a malodor reducing system, an alcohol, and a soil resist.

### BACKGROUND OF THE INVENTION

1. Field of the Invention

The present invention relates to wipes impregnated with a cleaning composition. More particularly, the present invention relates to a cleaning composition impregnated on a woven or non-woven wipe capable of removing stains from carpets, fabrics and other inanimate surfaces.

2. Description of the Prior Art

Fabric and carpet fibers may stain upon contact with water and proteinaceous materials, particulate matter, oily/greasy type soils, oxidizable materials, and numerous other materials. Such stains are conventionally removed by compositions containing combinations of cleansing surfactants that lift and remove the stains from the fabric. Stain removing compositions may also be formulated to further contain an array of enhancing agents including active oxygen-containing compounds, malodor reducing compounds, fragrances, skin softening and conditioning agents and anti-soiling agents, commonly referred to as soil resists that prevent or impede the re-soiling of the fabric after cleaning.

One type of soil resist, a fluorosurfactant, is described in U.S. Pat. Nos. 5,712,240 and 5,728,669, both to Tyerech et al. Compositions for reducing malodor impressions are described in U.S. Pat. No. 5,783,544 to Trinh et al. and include perfumes, metal salts and cyclodextrins.

In addition to providing acceptable stain removal ability, stain removal compositions must be stable for long periods of time under different conditions, and should be convenient to use. A cleaning wipe may be stored by the ultimate consumer for many months before use, and done so under less than ideal conditions. During storage, the components of the composition cannot separate from each other, be subject to microbial growth, or lose efficacy. The cleaning wipe must also prevent microbial growth that is inadvertently introduced during normal use in order to be acceptable to the consumer. This is accomplished with preservatives, which are disclosed in U.S. Pat. No. 5,783,544 to Trinh et al.

To prevent microbial growth in a wipe, and be convenient and easy to use, a cleaning composition impregnated on a wipe must maintain wetness of the wipe material to allow effective distribution of anti-bacterial and mold inhibition agents, i.e., preservatives. Exposure of the entire wipe to the cleaning solution may be accomplished in a number of ways including: through wicking action of the cleaning solution, inversion of the wipe and solution package, submersion of the wipe in the cleaning solution package, top filling of the cleaning solution over the wipe material, spraying of the cleaning solution onto the wipe material, or any combinations thereof.

### SUMMARY OF THE INVENTION

It is an object of the present invention to provide a cleaning wipe impregnated with a liquid cleaning composition.

It is another object of the present invention to provide such a cleaning wipe for use on fabric, carpet, and other inanimate surfaces.

It is yet another object of the present invention to provide a cleaning wipe in which the wipe's composition and integrity remain stable when stored in contact with the cleaning composition, where the wipe does not dry out during storage, and is resistant to microbial growth during both long and short term storage under a variety of conditions.

It is a further object of the present invention to provide a method for manufacture of such a cleaning wipe by pre-filling the wipe container with the cleaning composition prior to addition of the wipe material, without subsequent inversion of the package to wet the wipes, or top filling over the wipe material.

It is still a further object of the present invention to provide an article of manufacture comprising a cleaning composition impregnated on a wipe, and a suitable, re-sealable or single use container for dispensing the wipe.

These and other objects and advantages are achieved, in brief summary, by a cleaning wipe having a woven or non-woven wipe impregnated with a cleaning composition comprising a preservative system, a surfactant system and a carrier. The present invention may include one or more optional enhancing agents.

### DETAILED DESCRIPTION OF THE INVENTION

The present invention provides a cleaning composition impregnated into a wipe. Preferably, the cleaning composition has a preservative system, a surfactant system that includes one or more surfactants, and a carrier. Still further, the cleaning wipe may have one or more enhancing agents including a fragrance, a malodor reducing system, skin softening and conditioning agent, a pH control agent, a peroxygen component, an alcohol, a soil resist, or any combinations thereof.

As used in the present invention, the singular of a term includes the singular or plural of the term, unless otherwise indicated.

The cleaning wipe provides superior cleaning and ease of use while maintaining chemical stability, resisting microbial growth, and maintaining cleaning solution distribution throughout the entire wipe during storage.

The cleaning wipe is disposable, and primarily used in a single use modality, being made available for use in a resealable or single use container. Suitable containers include, for example, a canister, tub, tray, flexible pouch, and packette. The flexible pouch may be, for example, resealable, be contained in an outer carton, may have a plastic lid, or any combinations thereof.

The cleaning wipe is stored impregnated with the cleaning composition in a ready to use fashion. The cleaning wipe may be used to clean fabric, carpet, and other inanimate surfaces, such as, for example, a countertop, drawer, shelf, and metal fixture.

The wipe may be made of an absorbent or semi-absorbent material. It may be in the form of a woven, nonwoven, or partially woven sheet. It is preferable that the wipe, or wipe material be made of a substantially fibrous or semi-fibrous material. The material may be cotton, nylon, polyester, polyethylene, polypropylene, porous foam, rayon, reticulated foam, reticulated thermoplastic film, thermoplastic scrim, wood pulp, or any combinations thereof.

The wipe may be single surfaced or in the alternative may incorporate a backing member.

The backing member may be pervious or impervious to the cleaning solution. The backing member may be manufactured from a wide range of materials such as woven or non-woven material, polymeric material, natural fiber, synthetic fiber, or any combinations thereof. The backing member may provide structural support to the wipe, impart texture to the wipe, provide a prophylactic barrier, or any combinations thereof.

The wipe material may be used alone or in combination with binders that include, but are not limited to, lignin, starch, acrylic, vinyl acrylic, styrene-butadiene, and others known in the art. These binders may be used alone or in any combinations thereof.

The wipe may be formed from the wipe material by any process known to those skilled in the art. Such a process includes, but is not limited to carded/chemically or resin bonded, non-woven wipe carded/chemically or resin bonded, air laid chemically bonded, carded thermally bonded, airlaid thermally bonded, carded spunlaced or hydroentangled, wet laid chemically bonded, wet laid spunlaced or hydroentangled, meltblown, spunbond, apertured, needle punched, or any combinations thereof.

The wipe may also be smooth, textured, abrasive or any combinations thereof to aid in the ease of use by the end-user. In addition, it may be a three-dimensional, macroscopically-expanded, fluid pervious web.

The wipe may be provided or placed into the container in any fashion or method known to those skilled in the art. By way of example, the wipe may have a C-fold, a half fold, a Z-fold, a modified Z-fold, perforated in a roll, perforated and folded in a stack, interleafed, cross folded, quarter folded, or any combinations thereof.

One preferred form of the present invention has a composition with at least one preservative present in an amount effective to prevent spoilage and growth of inadvertently added microorganisms.

Acceptable preservative, or preservative systems include, but are not limited to, organic sulfur compound, halogenated compound, cyclic organic nitrogen compound, low molecular weight aldehyde, quaternary compound, phenyl and phenoxy compound, paraben, organic acid and its derivatives, iodophor, quaternary ammonium compound, urea derivative, isothiazoline, alkyl substituted amino acid, formaldehyde, formaldehyde donors including 1-(3-chloroallyl)-3,5,7-azoniaadamantane chloride sold by Dow Chemical Company under the trade name DOWICIL 75, 1,3-bis(hydroxymethyl)-5,5-dimethylhydantoin, 1-(hydroxymethyl)-5,5-dimethyl hydantoin, 3-iodo-2-propynyl butyl carbamate, the combination of the preceding three being sold by Lonza under the trade name PANTOGARD PLUS LIQUID, hexahydro-1,3,5-tris (2-hydroxyethyl)-s-triazine sold under the trade name SURCIDE-P, or any combinations thereof. More preferably, the present system has one or more formaldehyde donors. The most preferred preservative system is 1-(3-chloroallyl)-3,5,7-azoniaadamantane chloride.

When a preservative or preservative system is present, it is present in an amount about 0.001 weight percent (wt. %) to about 2 wt. % based on the total weight of the composition. The preservative or preservative system is more preferably present in an amount about 0.01 wt. % to about 1.0 wt. %, and most preferably present in an amount about 0.05 wt. % to about 0.15 wt. %, based on the total weight of the composition.

As stated above, a surfactant is used in the cleaning composition of the present invention. The surfactant or surfactant system has one or more surfactants. These surfactants are preferably mild surfactants. Such surfactants may be anionic, cationic, nonionic, zwitterionic, amphoteric surfactants, or any combinations thereof. Other suitable surfactants include, for example, amine oxide, fluorosurfactant, anionic fluorosurfactant, or any combinations thereof. The preferred surfactant system of the present invention has an anionic surfactant and a nonionic surfactant.

Suitable anionic surfactants include, but are not limited to, alcohol sulfate and sulfonate, alcohol phosphate and phosphonate, alkyl sulfate and sulfonate, alkylaryl sulfate and sulfonate, alkali metal or ammonium salt of fatty acid, sulfonated amine, sulfonated amide, fatty sarcosinate, linear alkylated sulfonate, alcohol ether sulfate, secondary alkane sulfonate, or any combinations thereof. The most preferred anionic surfactants for use in the present invention are sodium octyl sulfate, sodium caprylyl sulfonate, or any combination thereof.

Suitable nonionic surfactants that can be used in the cleaning composition of the present invention include, but are not limited to, ethoxylated (EO), propoxylated (PO), and inter-dispersed ethoxylated-propoxylated (EO-PO): alcohol, copolymer, fatty acid, alkyl phenol, polyglycoside, n-alkylpyrrolidone, block copolymer, or any combinations thereof. The most preferred nonionic surfactants are EO, PO, and EO-PO alkyl phenol, or any combinations thereof.

Suitable amphoteric surfactants include, but are not limited to, one or more betaines, specifically cocamidopropyl betaine, and amine oxide including fatty amine oxide such as lauramine oxide. Other amine oxides include alkyl EO, PO and EO-PO amine oxide, C₁₂-C₁₅ diethanol amine oxide, or any combinations thereof.

The surfactant or surfactant system, when present in the cleaning composition, is present in an amount about 0.1 wt. % to about 20 wt. % of the total weight of the composition weight. More preferably, the surfactant system is present in an amount about 0.5 wt. % to about 5 wt. %. Most preferably, the surfactant system is present in an amount about 1 wt. % to about 2 wt. % of the total weight of the cleaning composition.

In a preferred embodiment, the cleaning composition of the present invention has a carrier or vehicle, compatible with the preservative system, surfactant system and enhancing agent. The carrier may be water, one or more organic solvents, or any combination thereof.

Suitable organic solvents include, but are not limited to, alcohol, halogenated hydrocarbon, hydrocarbon, glycol, ethylene glycol, glycol ether, propylene glycol, propylene glycol methyl ether, dipropylene glycol, dipropylene glycol methyl ether, tripropylene glycol, tripropylene glycol methyl ether, methanol, ethanol, propanol, isopropanol, hexylcellosolve, butylcellosolve, methylcellosolve, aromatic hydrocarbon, ester, glycol ether ester, ketone, plasticizer, or any combinations thereof.

The preferred carrier is water. Preferably, the water is present in an amount that allows for the remainder of the components to be at their appropriate concentrations (Q.S., quantum sufficit).

Preferably, the cleaning composition of the present invention also includes one or more enhancing agents. These enhancing agents improve the stability, efficacy, ease, and pleasure of use by the end user. The enhancing agents that can be used in the present cleaning compositions include, but are not limited to, fragrance, malodor reducing ingredient or system, skin softening and conditioning agent, salt, pH control agent, peroxygen component, alcohol, soil resist, and combinations thereof.

Suitable fragrance for use in the present composition includes, but is not limited to, aromatic or an aliphatic ester having a molecular weight from about 130 to about 250; an aliphatic or an aromatic alcohol having a molecular weight from about 90 to about 240; an aliphatic ketone having a molecular weight from about 150 to about 260; an aromatic ketone having a molecular weight from about 150 to about 270; an aromatic or an aliphatic lactone having a molecular a weight from about 130 to about 290; an aliphatic aldehyde having a molecular weight from about 140 to about 200; an aromatic aldehyde having a molecular weight from about 90 to about 230; an aliphatic or an aromatic ether having a molecular weight from about 150 to about 270; or condensation product of aldehyde and amine having a molecular weight from about 180 to about 320.

When present, fragrance is preferably present in an amount about 0.001 wt. % to about 5 wt. %. More preferably, the fragrance is present in an amount about 0.05 wt. % to about 3 wt. %. The most preferred amount of fragrance is about 0.1 wt. % to about 0.3 wt. % of the total weight of the composition.

One or more malodor reducing agents or systems can also be used in the present invention. Malodor reducing agents that can be used in the present composition include, but are not limited to, cyclodextrin, inorganic acid, organic acid, metallic salt of inorganic and organic acid, enzyme or enzyme system, metazene, or any combinations thereof.

When present, the malodor reducing system is preferably present in an amount about 0.01 wt. % to about 10 wt. % by total weight of the composition. More preferably, the malodor reducing system is present in an amount about 0.05 wt. % to about 3 wt. %, and most preferably about 0.1 wt. % to about 2 wt. %, of the total weight of the composition.

One or more peroxygen compounds can be used in the present invention to aid in stain removal and efficacy of cleaning. Suitable peroxygen compounds include, but are not limited to, hydrogen peroxide, t-butyl hydroperoxide, sodium or other salts of percarbonate, sodium or other salts of perborate, or any combinations thereof. The preferred peroxygen compound is a high purity hydrogen peroxide.

When present, the peroxygen compound is preferably present in an amount about 0.2 wt. % to about 6 wt. % of the total weight of the composition. More preferably, the peroxygen compound is present in an amount about 1 wt. % to about 4 wt. %, and most preferably about 2.5 wt. % to about 3.5 wt. %, of the total weight of the composition.

As stated above, softening agents and skin conditioners can be used in the present invention. Suitable softening agents and skin conditioners that can be used in the present composition include, but are not limited to, quaternary ammonium chloride salt, silicone based conditioning system, imidazoline, lanolin and lanolin derivative, polyol, botanical derivative, vitamin, vitamin complex, or any combinations thereof.

When present, softening agents and skin conditioners are preferably present in an amount about 0.001 wt. % to about 5 wt. % of the total weight of the composition. More preferably, softening agents and skin conditioners are present in an amount about 0.05 wt. % to about 5 wt. %, and most preferably about 0.1 wt. % to about 1 wt. %, based on the total weight of the composition.

A pH control agent or system is useful in the present invention to maintain stability and ease of use. Suitable pH control agents include, but are not limited to, inorganic acid, inorganic base, salt of inorganic acid, organic acid, organic base, salt of organic acid, phosphorous compound including 1-hydroxyethylidene-1, 1-diphosphonic acid sold under the trade name DEQUEST 2010 by Monsanto Co., or any combinations thereof. Preferred suitable pH control agents include, but are not limited to, 1-hydroxyethylidene-1, 1-diphosphonic acid, sodium bicarbonate, sodium sulfate, sodium phosphate, sodium carbonate, citric acid, sodium citrate, or any combinations thereof. The pH control agent is incorporated in the present invention in an amount that produces the desired pH range.

The pH range of the cleaning composition is about 4 to about 12. The more preferred pH range is about 7.5 to about 10.5, with the most preferred range being about 8 to about 9.5. It has been found that controlling and maintaining the pH of the composition in the wipe contributes to the exceptional stability and microbial growth prevention of the present invention.

The cleaning composition of the present invention may also have one or more alcohols. Alcohol provides improved cleaning of certain types of stains over the non-alcohol containing prior art. The alcohol may act as a preservative, and improve composition wicking in the wipe material. This improvement in wicking may obviate the need to invert the wipe package during the manufacturing process prior to storage, or by the end user prior to use.

When present, the alcohol in the cleaning composition of the present invention may exhibit a preservative functionality. In addition, it has been unexpectedly found that the inclusion of alcohol in the present invention synergistically improves the storage stability of the impregnated cleaning wipe. The synergy discovered is believed to be due to the alcohol providing for mobility of the above-mentioned preservative in the present invention throughout the entire wipe matrix. This is especially important to prevent the top portion of the wipe from going dry, which would make it even more prone to microbial growth upon storage.

Suitable alcohols for use in the present invention include, but are not limited to, methanol, ethanol, propanol, isopropanol, n-butanol, sec-butanol, tert-butanol, or any combinations thereof. Ethanol is the preferred alcohol for use in a preferred embodiment of the present invention.

The alcohol in the present composition may be present in an amount about 1 wt. % to about 20 wt. % of the total weight of the composition. The alcohol is present more preferably in an amount about 5 wt. % to about 10 wt. %, and most preferably in an amount about 6 wt. % to about 8 wt. %, based on the total weight of the composition.

The cleaning composition of the present invention may also include a soil resist. The soil resist may be, for example, polymeric or copolymeric. Suitable polymeric or copolymeric soil resists include, but are not limited to, polymer derived from styrene-maleic anhydride copolymer resin, monomer of acrylic acid, methacrylic acid, methacrylate, methylmethacrylate, ethyl acrylate, maleic acid, and any copolymer derived from the above monomer. Still others may include, for example, polyvinylpyrrolidone, polyacrylate, modified cellulose polymer, polycarboxylate, vinyl acetate/maleic anhydride copolymer resin, cationic amine, aliphatic quaternary ammonium salts known to have anti-static properties, imidazoline salts, fluoroaliphatic oligomer or polymer, fluorinated hydrocarbon soil resist such as the ZONYL series from DuPont, fluorinated acrylate copolymer, or any combinations thereof.

Preferably, the polymeric or copolymeric soil resist is a mixture of acrylate polymers having a wide range of molecular weights. The preferred polymeric or copolymeric soil resist is a water-based carboxylated acrylic copolymer sold by Interpolymer Corporation under the trade name SYNTRAN DX6-125. The SYNTRAN DX6-125 soil resist is a water-based dispersion containing about 20 wt. % of a copolymer of methacrylic acid, methylmethacrylate and styrene, having a number average molecular weight about 6000 to about 8000. This dispersion has a specific gravity of about 1.055, a pH at 22° C. of about 8, and a viscosity at 22° C. of about 1000 cps (Brookfield) maximum. Most preferably, the soil resist is the fluorinated hydrocarbon soil resist of the type sold under the trade name ZONYL 7950 by DuPont.

When present, the soil resist is in the cleaning composition in an amount about 0.01 wt. % to about 4 wt. % of the total weight of the cleaning composition. More preferably, the soil resist is about 0.05 wt. % to about 0.5 wt. %. Most preferably, the soil resist is about 0.06 wt. % to about 0.15 wt. % of the total weight of the cleaning composition.

The cleaning composition loading level is defined herein as the ratio of the weight of cleaning composition to the weight of the wipe. The loading level is about 1:1 to about 10:1 respectively. More preferably, the cleaning composition loading level is about 2:1 to about 6:1, with the most preferred loading level being about 3:1 to about 4.5:1.

In use, the cleaning wipe impregnated with the cleaning composition according to the present invention would preferably be used on clothes, carpets, or other inanimate objects. The stain or area to be cleaned is wiped repeatedly with at least one of the impregnated wipes of the present invention, refolding the wipe as necessary until the desired degree of cleaning is achieved.

It is to be understood that although the cleaning wipe described herein has been generally discussed in conjunction with the cleaning of carpets, clothes and other inanimate objects, nonetheless, the present invention may be utilized in the cleaning of a wide variety of substrates including but not limited to those mentioned above.

The cleaning composition may be impregnated on the wipe of the present invention by any process known in the art. Such processes include spraying of the wipe, complete or partial dipping of the wipe, pre-filling a suitable container with cleaning solution prior to addition of the wipe, top filling the cleaning composition over the wipe material contained within a suitable container, submersing the wipe in the container, or any combinations thereof.

The superior wicking properties of the cleaning composition described previously in a preferred embodiment of the present invention, i.e., an alcohol containing cleaning composition, may, however, make inverting the wipe and cleaning composition package unnecessary.

One preferred cleaning composition of the present invention will have about 1 wt. % to about 20 wt. % alcohol, about 0.1 wt. % to about 20 wt. % surfactant, about 0.001 wt. % to about 2 wt. % preservative, about 0.01 wt. % to about 4 wt. % soil resist, and an aqueous carrier q.s. to 100 wt. %. The composition has a pH about 4 to about 12.

A more preferred cleaning composition of the present invention will have about 5 wt. % to about 10 wt. % alcohol, about 0.5 wt. % to about 5 wt. % surfactant, about 0.01 wt. % to about 1 wt. % preservative, about 0.05 wt. % to about 0.5 wt. % soil resist, and an aqueous carrier q.s. to 100 wt. %, with a pH about 7.5 to about 10.5.

A most preferred cleaning composition of the present invention will have about 6 wt. % to about 8 wt. % alcohol, about 1 wt. % to about 2 wt. % surfactant, about 0.05 wt. % to about 0.15 wt. % preservative, about 0.06 wt. % to about 0.15 wt. % soil resist, and an aqueous carrier q.s. to 100 wt. %, with a pH about 8 to about 9.5.

A cleaning wipe of the present invention was formed with the following ingredients in amounts expressed as percent by weight of the total weight of the cleaning composition.

| Option 1 Cleaning Composition | | |
|---|---|---|
| Non-Alcohol Cleaning Wipe | | |
| | Type of | Wt. % |
| Ingredients | Ingredient | Active |
| Water | Carrier | 97.4 |
| Sodium Octyl Sulfate/ | Surfactant | 1.6 |
| Sodium Caprylyl Sulfonate/ | | |
| Octoxynol-9 | | |
| Anionic Fluorosurfactant | Soil resist | 0.1 |
| Sodium Bicarbonate | Enhancing agent | 0.5 |
| 1-(3-chloroallyl)- | Preservative | 0.1 |
| 3,5,7-azoniaadamantane | | |
| chloride | | |
| Fragrance | Fragrance | 0.3 |

| Option 2 Cleaning Composition | | |
|---|---|---|
| Alcohol Containing Cleaning Wipe | | |
| | Type of | Wt. % |
| Ingredients | Ingredient | Active |
| Water | Carrier | 91.1 |
| Sodium Octyl Sulfate/ | Surfactant | 1.4 |
| Sodium Caprylyl Sulfonate/ | | |
| Octoxynol-9 | | |
| Anionic Fluorosurfactant | Soil resist | 0.1 |
| Ethanol | Alcohol | 6.5 |
| Sodium Bicarbonate | Enhancing agent | 0.5 |
| 1-(3-chloroallyl)- | Preservative | 0.1 |
| 3,5,7-azoniaadamantane | | |
| chloride | | |
| Fragrance | Fragrance | 0.3 |

| Wipe A | |
|---|---|
| Amount | Description |
| 4:1 | Loading ratio (by weight) of cleaning |
| | composition to wipe roll |
| 40 | Wipes per roll |
| 5.75″ × 7.5″ | Wipe dimensions |
| 40 g | Composite bulk fabric |
| 22.5-27.5% | Rayon Fiber |
| 22.5-27.5% | Polyester Fiber |
| 45-55% | Wood pulp fiber |
| 20-24% | Binder |

| Wipe B | |
|---|---|
| Amount | Description |
| 3.5:1 | Loading ratio (by weight) of cleaning |
| | composition to wipe roll |
| 30 | Wipes per roll |
| 5.75″ × 10.0″ | Wipe dimensions |
| 40 g | Composite bulk fabric |
| 22.5-27.5% | Rayon Fiber |
| 22.5-27.5% | Polyester Fiber |
| 45-55% | Wood pulp fiber |
| 20-24% | Binder |

The following examples of stain removal performance illustrate the effectiveness of the present invention when used to remove stains from fabrics and carpets.

### EXAMPLE 1(A)

### Product Efficacy Testing and Comparison

Testing was performed in the laboratory to demonstrate the ability of the compositions of the present invention in removing common stains typically found on rugs and carpets. Cut pile 100% nylon carpet swatches (4″×4″) in dimension were used for test purposes. Liquid and semi-viscous liquids were uniformly applied consistent with standard laboratory practice. The cleaning procedure was initiated after a two-hour dwell period. The test procedure used was as follows:

1. The stain was blotted repeatedly using white paper towels until no transfer occurred.

2. Seven grams of the non-wipe cleaning agents (Woolite® Spot and Stain and Resolve® Liquid) were applied to the stain and allowed to sit for a period of approximately one minute.

3. To rub the non-wipe cleaning agent into the stain, a damp colorfast sponge was used. The wipes of the present invention were used as prepared to rub the cleaning composition into the stain. Both the non-wipe cleaning agents and the wipe of the present invention were rubbed thirty times in a back and forth motion on the stain. For the non-wipe cleaner, the sponge was rinsed and used again to rub the cleaning agent into the stain an additional thirty times. The wipes of the present invention were used as prepared, but were re-folded to expose a clean area of the wipe prior to repeating the rubbing process an additional 30 times.

4. Test material was allowed to dry at ambient temperature, then vacuumed using five forward and five reverse strokes with a commercial upright beater bar vacuum.

5. An internal panel of twenty people assessed the appearance of the stain using the AATCC Gray Scale (see below).

| Gray Scale | Description |
|---|---|
| 5 | Negligible or no change |
| 4 | Slight change |
| 3 | Noticeable change |
| 2 | Considerable change |
| 1 | Severe change |

The scale is used to compare a stain that has been cleaned against two controls, an unstained fabric, and a stained fabric. A rating of 5 indicates that the remnants of the stain are negligible or undetectable and a rating of 1 indicates a severe difference between the stain that has been cleaned against an unstained fabric.

Results of this study are set forth in Table 1(A).

TABLE 1(A)
Alcohol and Non-Alcohol Wipe Efficacy

| | OPTION 1 | OPTION 1 | OPTION 2 | OPTION 2 | Woolite ® | |
|---|---|---|---|---|---|---|
| | WIPE A | WIPE A | WIPE A | WIPE A | Spot & | Resolve ® |
| STAIN | 1 WIPE | 2 WIPES | 1 WIPE | 2 WIPES | Stain | Liquid |
| Grape | 3.9 | 3.8 | 4.0 | 3.6 | 3.7 | 3.9 |
| Juice | | | | | | |
| Dirty | 2.8 | 3.8 | 1.6 | 4.2 | 2.9 | 4.5 |
| Motor Oil | | | | | | |
| Red Wine | 2.8 | 3.1 | 3.2 | 3.3 | 2.8 | 3.0 |
| Cola | 4.9 | 4.8 | 4.8 | 4.9 | 4.6 | 4.6 |
| Spaghetti | 4.9 | 4.7 | 4.7 | 4.9 | 4.8 | 4.7 |
| Sauce | | | | | | |

Results of this cleaning study clearly indicate the effectiveness of this invention both with and without alcohol, in removing stains from carpet.

### EXAMPLE 1(B)

### Alcohol Containing Product Efficacy Testing

For this example of cleaning performance, testing was performed by an independent testing laboratory to demonstrate the ability of a preferred embodiment of the present invention, Option 2-Wipe B, to remove common stains typically found on rugs and carpets. Twelve stains were evaluated. Test material used was continuous filament, cut pile, beige color stainmaster treated carpet, 100% nylon. Liquid and semi-viscous liquids were uniformly applied in a one inch diameter ring. The balances of the staining agents were applied as uniformly as possible consistent with standard laboratory practice. All stains were applied in duplicate. The cleaning procedure was initiated after a one-hour dwell period. The cleaning procedure employed was as follows:

1. The stain was blotted with paper towels until no more stain could be absorbed.

2. A single wipe fabric was removed from its canister.

3. The wipe was folded into enough surface area to cover and clean the stained area.

4. The wipe was used to rub the stain 30 times in a back and forth motion. The wipe was then re-folded to get to a clean area of the wipe, and the rubbing process was repeated an additional 30 times.

5. The test material was allowed to dry at ambient temperature, and then vacuumed.

6. A panel of three technicians assessed the appearance of the stain using the AATCC Gray Scale (see above).

7. Staining agents not removed to a rating of 5 were cleaned a second time. (A new, fully wet wipe was removed from the product canister and steps 3-6 were repeated.)

Results of this study are shown in Table 1(B).

TABLE 1(B)
Alcohol Wipe Efficacy

| | OPTION 2 | OPTION 2 |
|---|---|---|
| | WIPE B | WIPE B |
| Staining Agent | 1 WIPE | 2 WIPES |
| Grape Juice | 3.0 | 4.5 |
| Lipstick (Cosmetic) | 3.8 | 3.8 |
| Ketchup | 5.0 | — |
| Dog Urine | 5.0 | — |
| Red Wine | 2.6 | 4.0 |
| Foot Traffic Dirt | 3.4 | 3.9 |
| Coffee | 2.5 | 3.5 |
| (milk/sugar) | | |
| Cola | 4.3 | 5.0 |
| Spaghetti Sauce | 4.2 | 4.4 |
| Chocolate Milk | 2.6 | 3.3 |
| Baby Food— | | |
| Carrots | 4.2 | 4.8 |
| Mixed Vegetables | 4.2 | 4.8 |

Results of this study clearly indicate the effectiveness of this invention at removing a host of tough, common stains typically found on rugs and carpets.

### EXAMPLE 2

### Product Consumer Testing

The performance and consumer response of cleaning wipe Option 1 Wipe A (without alcohol) and cleaning wipe Option 2 Wipe A (with alcohol) were evaluated as new products for removing spots and stains from carpets, fabric, and upholstery. Product testing employed 200 people who claimed to have cleaned spots and stains from their carpet and upholstery within the last 3 months. Two cells of 100 people each were set up. Each product was used for two weeks. The data is set forth in Table 2.

TABLE 2
Non-Alcohol and Alcohol Wipe Consumer Testing

| | Option 2 | Option 1 |
|---|---|---|
| Attribute | Alcohol | Non-Alcohol |
| Rating System* | Top Box/Top 2 Box | Top Box/Top 2 Box |
| Cleaning | | |
| Cleans well overall | 64/90 | 72/90 |
| Effectively removes | 59/89 | 63/87 |
| spots and stains | | |
| Removes old stains | 25/46 | 30/53 |
| Removes fresh spills | 30/94 | 76/91 |
| Convenience | | |
| Is easy to use | 82/95 | 76/90 |
| Solves a problem for | 63/87 | 63/85 |
| you | | |
| Is convenient to use | 90/96 | 85/94 |
| Is easy to handle | 83/94 | 73/86 |
| Fragrance/Odors | | |
| Leaves carpet and/or | 64/88 | 72/92 |
| upholstery smelling | | |
| clean and fresh | | |
| Removes odors from | 40/66 | 44/68 |
| carpet and/or | | |
| upholstery | | |
| Has a pleasant scent | 69/91 | 75/94 |
| Safety | | |
| Is safe for all | 80/96 | 72/91 |
| carpets | | |
| Is safe to use | 83/96 | 76/90 |
| around children and | | |
| pets | | |
| Does not discolor | 91/98 | 89/99 |
| carpet | | |
| Miscellaneous | | |
| Does not leave a | 80/96 | 80/93 |
| residue | | |
| Wipe fabric does not | 87/96 | 76/92 |
| fall apart during | | |
| use | | |

*Rating system indicates the number of respondents that chose either the top rating (Top Box) or the top rating plus the second to top rating (Top 2 Box).

Overall, each embodiment of the present invention was well received by the participants in this study. High acceptance ratings on almost all key attributes including cleaning, convenience, fragrance/odor and safety clearly demonstrate how well these products performed.

### EXAMPLE 3

### Product Stability Testing

Summary of the Eight Week Preservative Challenge Screen for Cleaning Composition Impregnated on Wipe.

A. Innoculum Preparation

Cultures were obtained from trypticase soy agar (TSA) slants (bacteria) and sabouraud dextrose agar (SDA) slants (mold and yeast). One loopful of each bacteria strain was transferred to trypticase soy broth and one loopful of yeast was transferred to sabouraud dextrose broth. Mold was transferred to SDA plates. The bacteria and yeast were incubated at 35° C. for 18 to 24 hours. Mold was incubated at 25° C. for approximately 7 days. After incubation, bacteria and yeast broth samples were centrifuged for 30 minutes at 3000 rpm. Mold spores were suspended in phosphate buffer saline and centrifuged for 30 minutes at 3000 rpm. After centrifuging, bacteria suspensions were made to yield about 1.0×10⁶ to about 2.0×10⁶ bacteria and about 1.0×10⁶ to about 2.0×10⁵ mold per ml.

| B. Test Organisms | |
|---|---|
| P. aeruginosa | ATCC #9027 |
| S. aures | ATCC #6538 |
| E. coil | ATCC #8738 |
| C. aibicans | ATCC #10231 |
| A. niger | ATCC #16404 |

C. Product Preparation and Inoculation

One sample was inoculated for each test organism. Evaluations included inoculation via 1 of 2 methods: top inoculation, whereby the top of each wipe roll was completely wetted with the appropriate amount of inoculum; or 5 spot inoculation, where each individual wipe was inoculated with 100 μl of innoculum at each corner, and at the center of the wipe. The samples were stored at room temperature and re-inoculated at Day 28.

D. Recovery of Inoculated Organisms

Assay of the inoculated samples were done at the following time intervals after inoculation: Day 7, 14, 21, 28, 35, 42, 49, and 56. Samples were re-inoculated after plating on day 28.

Assay Procedure

Using sterile forceps, three wipes were aseptically removed from the center of each roll and placed into 100 ml Letheen broth bottles. The bottles were then placed on an orbital shaker for 30 minutes at 250 rpm. After shaking, 1 ml of each sample was pipetted into a separate petri dish. 15-20 ml of TSA were poured into each plate for bacterial challenged samples and 15-20 ml of SDA into each plate for yeast and mold challenged samples. The plates were swirled and then allowed to solidify. The bacteria plates were then incubated at 30° C. for 3 days. The mold and yeast plates were incubated at 25° C. for at least 5 days. After the appropriate incubation time, a colony count was made.

E. Interpretation of Results

Effective preservative systems are determined as follows:

Bacteria: A 3 log reduction (99.9%) by day 7 after each inoculation (day-7 and day-35) and no increase at any time during the 8 week test period.

Fungi: A 2 log reduction (99%) by day 7 after each inoculation (day-7 and day-35) and no increase during the 8 week test period.

Results are in Table 3.

TABLE 3

| Sample # | | Results* | |
|---|---|---|---|
| Description | Day | Bacteria | Fungi |
| 1) | | | |
| Non-Preserved | 21 | — | NE |
| Non-Alcohol | | | |
| Non-Inverted | | | |
| 2) | | | |
| Preserved | 21 | — | NE |
| Non-Alcohol | | | |
| Non-Inverted | | | |
| 3) | | | |
| Non-Preserved | 21 | — | NE |
| Alcohol | | | |
| Non-Inverted | | | |
| 4)** | | | |
| Option 1 Wipe A | 56 | E | E |
| Preserved | | | |
| Non-Alcohol | | | |
| Inverted | | | |
| 5) | | | |
| Option 2 Wipe A | 56 | E | E |
| Preserved | | | |
| Alcohol | | | |
| Non-Inverted | | | |
| 6) | | | |
| Option 2 Wipe B | 56 | E | E |
| Preserved | | | |
| Alcohol | | | |
| Non-Inverted | | | |

*E-Effective; NE-Non-Effective
**5 spot inoculation

In comparing the above samples, the absence of product inversion, either with or without alcohol and with or without a preservative (Samples 1, 2 and 3 respectively) yields a non-acceptable product due to mold growth. However, as samples 4, 5 and 6 demonstrate, inversion with a preservative but without alcohol or non-inversion with a preservative and with alcohol, produce an acceptable product in terms of an effective preservative.

This data also demonstrates the superior wicking capability of the alcohol containing form of the present invention and the synergy between the alcohol and preservative system.

The present invention has been described with particular reference to the preferred forms thereof. It will be obvious to one of ordinary skill in the art that changes and modifications may be made therein without departing from the spirit and scope of the present invention as defined by the following claims.

What is claimed is:

1. A cleaning wipe comprising a cleaning composition, the cleaning composition comprising:
at least one surfactant system;
at least one preservative system; and
a carrier,
wherein the cleaning composition is adjusted to a pH about 7.5 to about 10.5 and wherein the wipe has a loading level ratio about 1:1 to about 10:1, based on a total weight of the cleaning composition to a total weight of the wipe.

2. The wipe of claim 1, wherein said at least one surfactant system is about 0.1 wt. % to about 20 wt. % of the total weight of the composition.

3. The wipe of claim 1, wherein said at least one surfactant system is at least one surfactant selected from the group consisting of an anionic surfactant, a cationic surfactant, a nonionic surfactant, a zwitterionic surfactant, an amphoteric surfactant, an amine oxide surfactant, a fluorosurfactant, an anionic fluorosurfactant, and any combinations thereof.

4. The wipe of claim 1, wherein said at least one surfactant system is at least one surfactant selected from the group consisting of one of more anionic surfactants, nonionic surfactants, and any combinations thereof.

5. The wipe of claim 1, wherein said at least one preservative system is at least one preservative selected from the group consisting of one or more organic sulfur compounds, halogenated compounds, cyclic organic nitrogen compounds, low molecular weight aldehydes, quaternary compounds, phenyl and phenoxy compounds, parabens, organic acids and their derivatives, iodophors, quaternary ammonium compounds, urea derivatives, isothiazolines, alkyl substituted amino acids, formaldehyde, formaldehyde donors, and any combinations thereof.

6. The wipe of claim 5, further comprising an effective amount of said preservative sufficient to prevent spoilage or prevent growth of inadvertently added microorganisms.

7. The wipe of claim 1, wherein said at least one preservative system is about 0.001 wt. % to about 2 wt. % of the total weight of the composition.

8. The wipe of claim 1, wherein said carrier is selected from the group consisting of water, alcohol, halogenated hydrocarbon, hydrocarbon, glycol, ethylene glycol, glycol ether, propylene glycol, propylene glycol methyl ether, dipropylene glycol, dipropylene glycol methyl ether, tripropylene glycol, tripropylene glycol methyl ether, methanol, ethanol, propanol, isopropanol, hexylcellosolve, butylcellosolve, methylcellosolve, and any combinations thereof.

9. The wipe of claim 1, wherein said carrier is water.

10. The wipe of claim 1, further comprising at least one enhancing agent.

11. The wipe of claim 10, wherein said at least one enhancing agent is selected from the group consisting of pH control agent, fragrance, malodor reducing system, peroxygen compound, skin softening and conditioning agent, alcohol, soil resist, and any combinations thereof.

12. The wipe of claim 11, wherein said pH control agent is present in an amount so that the composition has a pH about 7.5 to about 10.5.

13. The wipe of claim 11, wherein said pH control agent is the salt of an acid.

14. The wipe of claim 11, wherein said pH control agent is selected from the group consisting of 1-hydroxyethylidene-1,1-diphosphonic acid, citric acid, sodium bicarbonate, sodium citrate, sodium sulfate, sodium phosphate, sodium carbonate, and any combinations thereof.

15. The wipe of claim 11, wherein said peroxygen compound is selected from the group consisting of hydrogen peroxide, t-butyl hydroperoxide, sodium percarbonate, sodium perborate, and any combinations thereof.

16. The wipe of claim 15, wherein said hydrogen peroxide is a high purity hydrogen peroxide.

17. The wipe of claim 11, wherein said skin softening and conditioning agent is selected from the group consisting of lanolin, lanolin derivative, polyol, botanical derivative, vitamin, vitamin complex, silicone, quaternary surfactant, and any combinations thereof.

18. The wipe of claim 11, wherein said alcohol is selected from the group consisting of methanol, ethanol, propanol, isopropanol, butanol, secondary butanol, tertiary butanol, and any combinations thereof.

19. The wipe of claim 11, wherein said alcohol is present in an amount about 1 wt. % to about 20 wt. % of the total weight of the composition.

20. The wipe of claim 11, wherein said soil resist is about 0.01 wt. % to about 4 wt. % of the total weight of the composition.

21. The wipe of claim 11, wherein said soil resist is selected from the group consisting of polymer derived from styrene-maleic anhydride copolymer resin, monomer of acrylic acid, methacrylic acid, methacrylate, methylmethacrylate, ethyl acrylate, maleic acid, any copolymer derived from the above monomer, olefin, polyvinylpyrrolidone, polyacrylate, modified cellulose polymer, polycarboxylate, vinyl acetate/maleic anhydride copolymer resin, cationic amine, aliphatic quaternary ammonium salt known to have anti-static properties, imidazoline salt fluoroaliphatic oligomer or polymer, fluorinated acrylate copolymer, anionic fluorosurfactant, and any combinations thereof.

22. The wipe of claim 11, wherein said soil resist is selected from the group consisting of a fluoroaliphatic oligomer or polymer, fluorinated acrylate copolymer, anionic fluorosurfactants, and any combinations thereof.

23. The wipe of claim 1, wherein the wipe is produced from a process selected from the group consisting of carded/chemically or resin bonded, non-woven wipe carded/chemically or resin bonded, air laid chemically bonded, carded thermally bonded, airlaid thermally bonded, carded spunlaced or hydroentangled, wet laid chemically bonded, wet laid spunlaced or hydroentangled, meltblown, spunbonded, apertured, needle punched, and any combinations thereof.

24. The wipe of claim 1, wherein the wipe is formed from a material selected from the group consisting of fiber, porous foam, reticulated foam, reticulated thermoplastic film, thermoplastic scrim, and any combinations thereof.

25. The wipe of claim 24, wherein said fiber is selected from the group consisting of polyester, rayon, nylon, polypropylene, polyethylene, cotton, wood pulp, and any combinations thereof.

26. The wipe of claim 24, wherein the wipe has said fiber and at least one binder.

27. The wipe of claim 1, wherein the wipe has a textured surface, smooth surface, abrasive surface, and any combination thereof.

28. The wipe of claim 1, wherein the wipe has a backing surface.

29. The wipe of claim 28, wherein said wipe backing surface is a surface selected from the group consisting of non-permeable, permeable, semi-permeable, and any combinations thereof.

30. The wipe of claim 1, wherein the wipe has a loading level ratio about 2:1 to about 6:1.

31. The wipe of claim 1, wherein the wipe has a loading level ratio about 3:1 to about 4.5:1.

32. A cleaning wipe having a cleaning composition, the cleaning composition comprising:
about 0.001 wt. % to about 2 wt. % preservative system;
about 0.1 wt. % to about 20 wt. % surfactant system;
about 1 wt. % to about 20 wt. % alcohol;
about 0.01 wt. % to about 4 wt. % soil resist; and
q.s. aqueous carrier.

33. A method of producing the cleaning wipe of claim 1, which comprises:
(a) placing the wipe in a container;
(b) dispensing the composition into said container; and
(c) sealing said container.

34. The method of claim 33, wherein said sealed container is inverted.

35. The method of claim 33, wherein said sealed container is not inverted.

36. A method of producing the cleaning wipe of claim 1, which comprises:
(a) dispensing the composition into a container;
(b) placing the wipe into said container; and
(c) sealing said container.

37. The method of claim 36, wherein said sealed container is inverted.

38. The method of claim 36, wherein said sealed container is not inverted.

39. A method of producing the cleaning wipe of claim 1, which comprises:
(a) spraying the composition onto the wipe;
(b) placing the wipe into a container; and
(c) sealing said container without inverting said container.

40. A method of producing the cleaning wipe of claim 1, which comprises:
(a) spraying the composition onto the wipe;
(b) placing the wipe into a container;
(c) sealing said container; and
(d) inverting said container.
